(19) United States
(12) Patent Application Publication
(10) Pub. No.: US 2019/0094801 A1
(43) Pub. Date: Mar. 28, 2019

(54) Holographic Cap and Method of Making Same

(71) Applicant: Silgan White Cap LLC, Downers Grove, IL (US)

(72) Inventors: Wayne Hohl, Mokena, IL (US); Thomas P. Hennessey, Naperville, IL (US); Andrew Wnuk, Itasca, IL (US)

(21) Appl. No.: 16/141,275

(22) Filed: Sep. 25, 2018

Related U.S. Application Data
(60) Provisional application No. 62/562,520, filed on Sep. 25, 2017.

(51) Int. Cl. G03H 1/02; G03H 1/22

(52) U.S. Cl. CPC G03H 1/0248; G03H 2001/0204; G03H 1/2249

(57) ABSTRACT

A closure having a design comprising holographic and non-holographic portions is described. The closure comprises a top panel and a skirt that extends downwards from the outer periphery of the top panel. The skirt's outer surface and the top panel's upper surface collectively comprising an external surface that may be covered by a design, which has a first design portion with a hologram and a second design portion without a hologram.

### CROSS-REFERENCE TO RELATED PATENT APPLICATIONS

The application claims priority to and the benefit of U.S. Provisional Application No. 62/562,520, filed Sep. 25, 2017, the contents of which are incorporated herein in their entirety.

### BACKGROUND OF THE INVENTION

The present disclosure relates generally to the field of closures. The present disclosure relates specifically to a closure having a design formed at least in part by a hologram.

### SUMMARY OF THE INVENTION

In one embodiment, a closure is described comprising a top panel having an upper surface, a lower surface and an outer periphery. A skirt extends downwards (e.g., perpendicularly) from the outer periphery of the top panel. The skirt's outer surface and the top panel's upper surface collectively comprise an external surface that is covered by a design. The design comprises a first design portion with a hologram and a second design portion without a hologram.

In another embodiment, a metallic sheet is formed to create container closures. The sheet comprises upper and lower surfaces, leading and trailing ends, and a top end and a bottom end. The sheet also includes a plurality of equally sized circles along the upper surface. At least one of the plurality of equally sized circles are surrounded by six circles from the first plurality of circle, such as by six circles that are symmetrically around the reference circle. The sheet also includes a second plurality of circles arranged within the first plurality of circles (e.g., the second plurality of circles are concentrically located within the first plurality of circles).

In another embodiment, a method of forming the closures is described. The method comprises providing a metallic sheet, forming a holographic design portion and a non-holographic design portion on an upper surface of the sheet. Subsequently, one or more cup-shaped members are cut from the sheet, the one or more cup-shaped members comprising a top panel and an annular skirt.

In one embodiment, a design on the closure covers the entirety of the outer surface of the top panel and the skirt. The design comprises a first design portion with a hologram and a second design portion without a hologram.

In one embodiment, at least a part of the second design portion does not cover the same portions (e.g., top panel, skirt) of the closure that the first design portion covers. In another embodiment, no part of the second design portion extends along the same portion of the outer surface of the closure about which the first design portion extends. In yet another embodiment, the first design portion only covers the top panel.

The closure may include a plurality of knurls extending around an upper portion of the skirt. A tamper band may be formed along a lower portion of the skirt. An annular portion is defined between the knurls and the tamper band. The first design portion may extend along only the top panel and the annular portion of the skirt.

In one embodiment, the second design portion comprises one or more printed layers. The second design portion may be oriented and aligned along the outer surface of the closure relative to the first design portion. A layer of varnish may extend along the outer surface of the closure.

In one embodiment, a generally rectangular metallic sheet is configured to form one or more container closures having a diameter D that comprise an upper surface, a lower surface, a leading end, a trailing end, a top end, and a bottom end. A first plurality of equally sized circles are defined along the upper surface of the sheet. The first plurality of circles have an outermost periphery defining a first boundary.

A least one of the first plurality of equally sized circles is immediately surrounded by six other circles from the first plurality of circles. The six circles are spaced symmetrically about the outermost periphery of the at least one circle. The first plurality of circles are arranged in a repetitive pattern along the upper surface of the sheet.

A second plurality of equally sized circles is defined concentrically within each of the circles of the first plurality of circles. One or more holograms are formed about the upper surface of the sheet. The holograms extend along those portions of the sheet corresponding to areas defined within the second plurality of equally sized circles. In one embodiment, the sheet is made of aluminum.

In one embodiment, the one or more holograms only extend along the portion of the upper surface within the first boundaries defined by the first plurality of circles. In one embodiment, the one or more holograms only extend along the portion of the upper surface extending within the second plurality of circles. A non-holographic design may extend along a portion of the upper surface located within the first boundaries defined by the first plurality of circles.

In one embodiment, the non-holographic design only extends along the portions of the upper surface located within the first boundaries defined by the first plurality of circles. In one embodiment, the non-holographic design only extends along the portions of the upper surface located between the first boundaries defined by the first plurality of circles and the outer peripheries of the second plurality of circles. The sheet may be arranged in a rolled, coiled arrangement.

In one embodiment, a method of forming a closure is described having a holographic design comprising providing a metallic sheet of material and forming one or more holograms along an upper surface of the sheet. A non-holographic design is created along the upper surface of the sheet. One or more cup-shaped members are formed from the sheet. The one or more cup-shaped members each comprise a top panel and an annular skirt.

In one embodiment, the sheet is registered prior to creating the non-holographic design such that the non-holographic design is aligned to create the non-holographic design at desired locations along a length of the sheet. The sheet may be indexed prior to creating the non-holographic design such that the non-holographic design is formed at a desired orientation along the sheet. The alignment of the non-holographic design during registering may be based on the relative alignment of the holographic design along the upper surface of the sheet. The orienting of the non-holographic design during indexing may be based on the relative orientation of the holographic design along the upper surface of the sheet. In one embodiment, the one or more holograms are only formed along those portions of the sheet that correspond to portions of the sheet that form the top panels of the cup-shaped members. The non-holographic design may comprise one or more layers of printing.

A knurl may be formed along a portion of the annular skirt. The cup-shaped member may be mounted onto a mandrel to form the knurl. The hologram may be formed along an upper surface of the sheet after the cup-shaped member has been mounted onto the mandrel. The non-holographic design may be formed prior to or subsequent to the cup-shaped member being mounted onto the mandrel.

In one embodiment, the hologram is formed along an upper surface of the sheet during the forming of the one or more cup-shaped members. A tamper band may be formed along a lower portion of the annular skirt. A liner may be added to an inner portion of a cup-shaped member. A layer of varnish may be added following forming the hologram and the non-holographic design. The cup-shaped member may be embossed or debossed after forming the hologram.

### BRIEF DESCRIPTION OF THE DRAWINGS

This application may be more fully understood from the following detailed description, taken in conjunction with the accompanying figures, wherein like reference numerals refer to like elements in which:

FIG. 1A depicts a closure embodiment having decorative designs formed of holographic and non-holographic designs;

FIG. 1B depicts a closure embodiment having decorative designs formed of holographic and non-holographic designs;

FIG. 1C depicts a closure embodiment having decorative designs formed of holographic and non-holographic designs;

FIG. 2A depicts an embodiment of a roller that may be used to form holograms;

FIG. 2B depicts an embodiment of a stamp plate that may be used to form holograms;

FIG. 2C depicts an embodiment of a roller that may be used to form holograms;

FIG. 2D depicts an embodiment of a stamp plate that may be used to form holograms;

FIG. 3A depicts an embodiment of a hologram pattern that may be formed on a material;

FIG. 3B depicts an embodiment of a hologram pattern that may be formed on a material;

FIG. 3C depicts a top view of an embodiment of a closure stamped from a sheet;

FIG. 3D depicts a side view of the closure of FIG. 3C;

FIG. 3E depicts an embodiment of a hologram pattern may be formed on a material;

FIG. 4 depicts an exemplary method of forming closures having decorative designs of holographic and non-holographic designs;

FIG. 5 depicts an exemplary method of forming closures having decorative designs of holographic and non-holographic designs;

FIG. 6 depicts an exemplary method of forming closures having decorative designs of holographic and non-holographic designs; and

FIG. 7 depicts an exemplary method of forming closures having decorative designs of holographic and non-holographic designs.

### DETAILED DESCRIPTION

Various embodiments of closures are described in this disclosure that comprise holographic-design portions and non-holographic design portions. The combination of holographic-design portions and non-holographic-design portions cover various surfaces on the closures described herein (e.g., the holographic-design portions are only on the top surface, the holographic-design portions are only on the skirt, the holographic-design portions and the non-holographic-design portions are on separate surfaces of the closure).

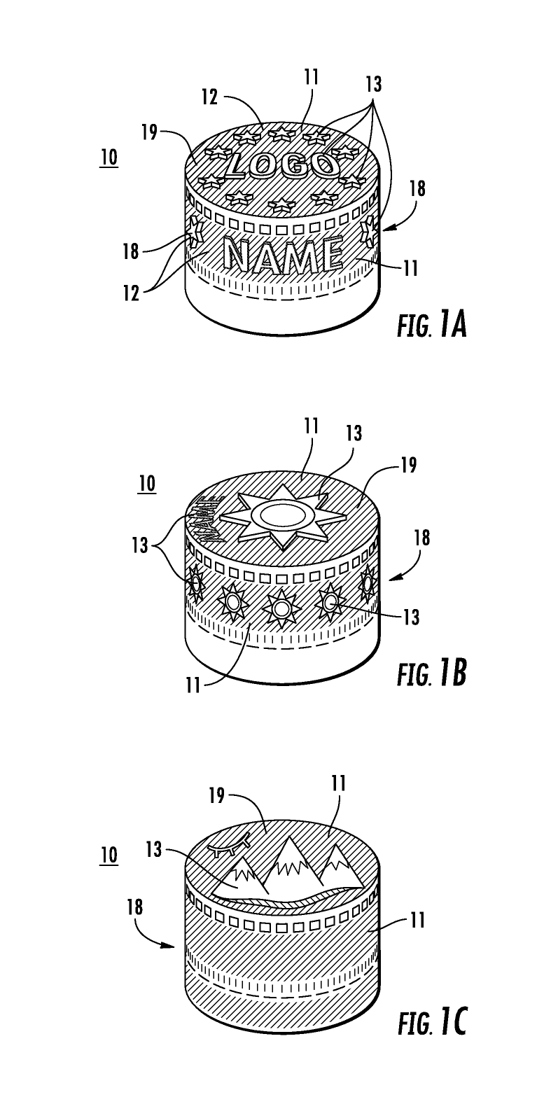

Illustrated in FIGS. 1A-1C are various embodiments of closures 10 formed with an enhanced, visual decorative design 12 created by an interplay between holographic 11 and non-holographic 13 portions of the closure 10. The holographic 11 and non-holographic 13 portions of closure 10 design may be formed on any portions of closure 10.

In FIG. 1A, both holographic 11 portions and non-holographic 13 portions cover each of top panel 19 and skirt 18. Similarly, in FIG. 1B both holographic 11 portions and non-holographic 13 portions cover each of top panel 19 and skirt 18. In FIG. 1C, both holographic 11 portions and non-holographic 13 portions cover top panel 19, while only holographic 11 portions cover skirt 18.

In some embodiments, holographic 11 portions of design 12 may be limited to those portions of closure 10 defined by top panel 19. In other embodiments, holographic 11 portion(s) of design 12 may be limited to those portion of closure 10 defined by skirt 18. In other embodiments, holographic 11 portions of design 12 may be formed on both top panel 19 and skirt 18 portions of closure 10. In other embodiments, holographic 11 portions cover at least part of top panel 19 while non-holographic portions 13 do not cover any of top panel 19. In still other embodiments, holographic 11 portions cover at least part of skirt 18 while non-holographic portions 13 do not cover any of skirt 18.

In various embodiments, closure 10 may be produced such that hologram(s) are formed on the material forming closure 10 only along those portions of the material that correspond to holographic 11 portions forming the decorative design of closure 10. In other embodiments, holograms may be formed along portions of the material forming closure 10 that do not correspond to holographic 11 portions forming the decorative design the closure 10 (e.g., such as those portions of the material over which a printed design is formed), such that all or some of non-holographic 13 portions of the decorative design of closure 10 (e.g. printing) are formed on top of holograms.

In some embodiments, non-holographic 13 portions of closure 10 may be decorated with one or more coats of printed material. In some embodiments, non-holographic 13 portions of closure 10 may be defined by one or more non-holographic treatments of the surface (e.g. etching, embossing, non-hologram forming debossing, etc.). In some embodiments, the one or more portions of the surface of closure 10 forming non-holographic 13 portions of closure 10 may be untreated portions of the material used to form closure 10. In some embodiments, non-holographic 13 portions of closure 10 may be any combination of such treatments/non-treatment of the closure-forming material.

Any number of methods and/or devices may be used to form the hologram(s) forming holographic 11 portions of design 12 of closure 10. In some embodiments, the hologram(s) may be formed in the surface of the material by utilizing one or more surface relief patterns 40 that are pressed into the surface of the material forming closure 10 to micro-deboss the surface of the material to form holographic 11 portions of design 12 of closure 10. In various embodiments, the creation of the hologram in closure 10 and/or in the material used to form closure 10 may be accomplished using any other known hologram-forming techniques, such as e.g. laser and/or chemical etching.

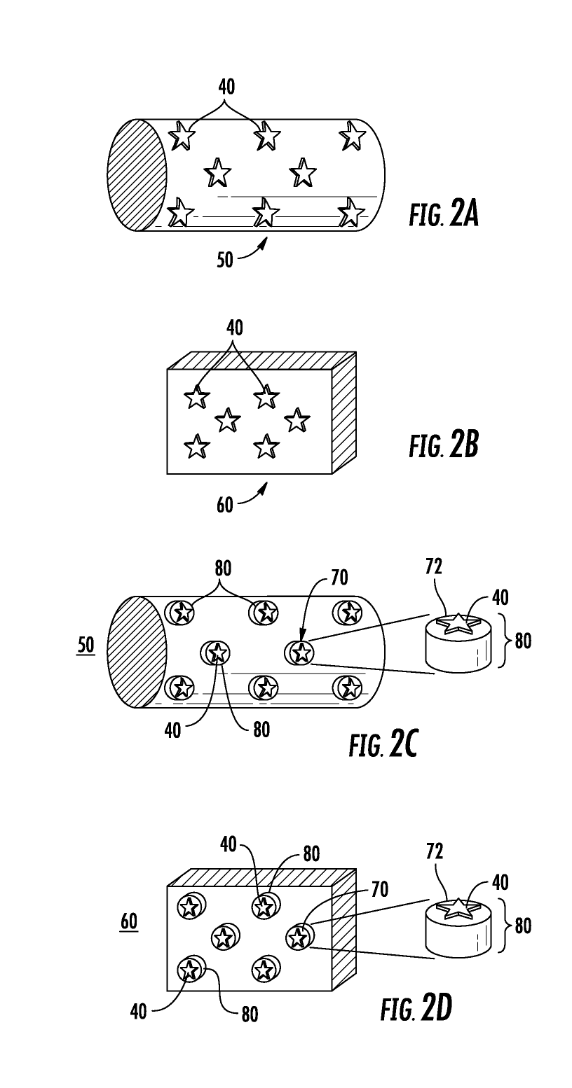

Referring to FIG. 2A, in one embodiment, one or more surface relief patterns 40 may be arranged about the outer surface of a roller 50 which is rolled over closure 10 and/or the material (e.g. aluminum sheet) used to form closure 10 in order to form holographic 11 portion of the closure's design 12. As depicted in FIG. 2A, in various embodiments roller 50 may be formed of a continuous surface that is integrally and monolithically formed with one or more surface relief patterns 40. In other embodiments, such as for example shown in FIG. 2B, surface relief pattern 40 may be arranged about stamp plate 60 that may be pressed down upon closure 10 and/or the material used to form closure 10 in order to form the holographic 11 portion of the closure's design 12.

Because relief patterns 40 may wear down with use, leading to less pronounced holograms being formed on closure 10 and/or the material used to form closure 10, it may be necessary to replace roller 50 and/or stamp plate 60 after a period of use. Accordingly, in some embodiments, such as illustrated in FIGS. 2C and 2D, roller 50 and/or stamp plate 60 may be formed with one or more apertures 70 that receive insets 72. These apertures 70 are sized to removably receive insets 72 of height 80 formed with one or more surface relief patterns 40. As depicted, a single inset 72 has a single pattern 40, although in various embodiments inset 72 may comprise multiple patterns 40. When surface relief pattern 40 needs to be replaced (e.g. due to wear or because it is desired to create a different hologram design), the replacement of the desired surface relief pattern 40 of the roller 50 and/or stamp plate 60 can be effectuated without requiring the replacement of the entire roller 50 and/or stamp plate 60, such as by replacing one or more insets 72 up to and includes replacing all insets 72 in apertures 80.

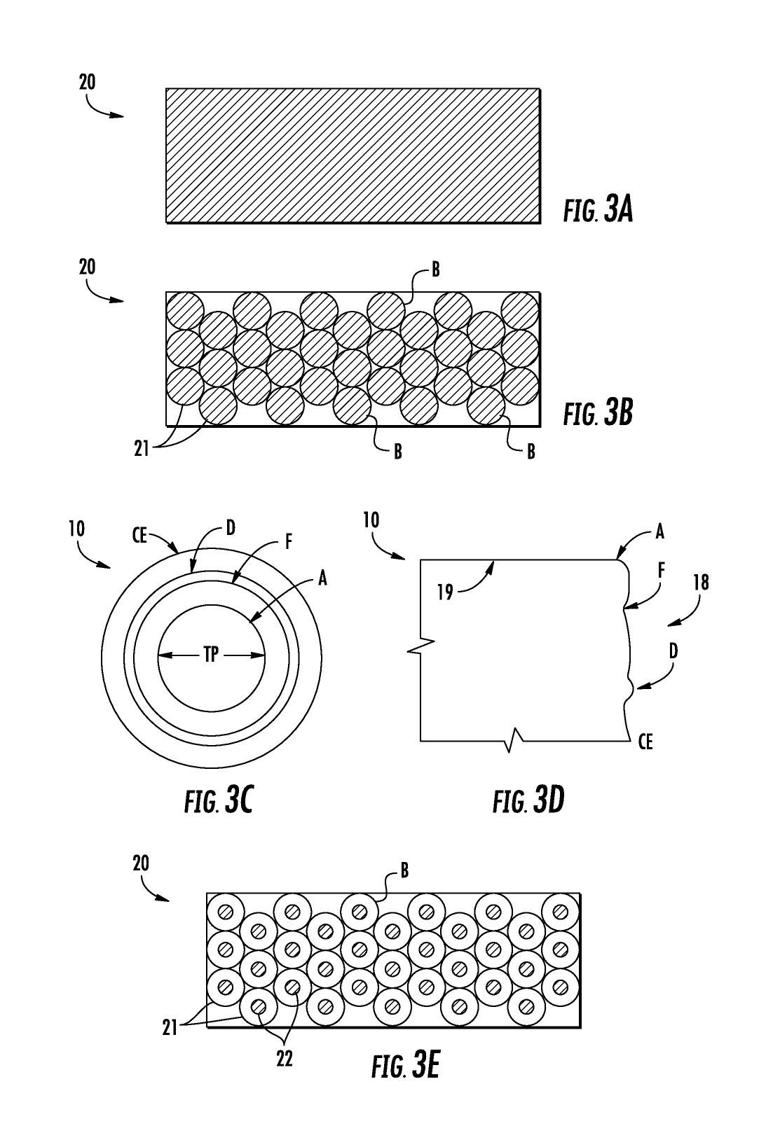

Turning to FIGS. 3A-3E, in some embodiments the hologram(s) creating holographic 11 portion(s) of closure 10 design 12 may be formed in the closure-forming material prior to the formation of closure 10 from the material. In such embodiments, the hologram(s) forming holographic 11 portion(s) of the design may be formed along any portion of sheet 20 of the material that is to be formed into closure 10. For example, as illustrated in FIG. 3A, in one embodiment, the hologram(s) may be formed across the entirety of sheet 20 of the material.

However, in some embodiments, it may be desirable to minimize the creation of hologram(s) on the material by limiting the formation of hologram(s) to only those portions of the material that will correspond to holographic 11 portions of closure 10. Specifically, because (as described above) the creation of holograms may cause wear on the tooling used to form the holograms, limiting the creation of holograms to only those portions of the material that correspond to holographic 11 portions may increase the lifespan of the hologram-forming tools.

Accordingly, as illustrated in FIG. 3B, in some embodiments it may be desired to form holograms on those portions of the material lying entirely within circles defined by boundaries B. The boundaries B define the outer diameters of blanks that will be cut from sheet 20 of the material and which will be punched into cup-shaped members during the closure forming process.

In some embodiments, sheet 20 comprises a first plurality 21 of circles. The first plurality 21 of circles may be arranged in a repetitive pattern, such as a first plurality 21 of equally sized circles (e.g., FIG. 3B). In other embodiments, a second plurality 22 of circles are also arranged on sheet 20, and the second plurality 22 of circles are arranged within the first plurality 21 of circles (e.g., FIG. 3E).

As will be discussed in further detail below, the cup-shaped members formed from the circular, disc-like blanks B punched from the material form closure 10 having top panel 19 and skirt 18. During the drawing process in which cup-shaped members are formed from the blanks, the portion of the material defining the blank that forms skirt 18 may be deformed, with any hologram that may be formed along this portion of the blank also potentially being deformed and/or distorted during the drawing process. Thus, in some embodiments, holograms formed along skirt 18 of closure 10 may not contribute to holographic 11 portion that produces the desired overall design effect on closure 10.

Accordingly, given that holograms that are formed along portions of the blank that do not become top panel 19 of closure 10 may not necessarily contribute to desired closure 10 design 12, in some embodiments it may also be desirable to avoid forming holograms along those portions of the material that will not form top panel 19 of closure 10. As such, referring to FIG. 3C, in some embodiments it may be desired that any hologram(s) formed on the closure-forming material be limited to those areas of material located entirely within the boundaries defined by circles TP, and which correspond to those portions of the material that will define top panel 19 of closure 10.

For reasons described above, holograms formed on portions of material extending between circles TP and F may not contribute to holographic 11 portions of overall closure design 12, and as such it may be desired not to form holograms on those portions of the material corresponding to location in between circles TP and F.

Another reason why it may be desirable to not form holograms on those portions of the material corresponding to locations between circles TP and F is that micro-debossing the surface of the material to form a hologram(s) in such locations would increase the unevenness and abrasiveness of the material extending between circle TP and F. Because the increased abrasiveness of a material being worked on by a tool may increase the wear on a tool, avoiding the creation of an abrasive surface along those portions of the material extending between circles TP and F may prevent wear on the tools working on the material during the punch and draw steps of closure formation.

Referring to FIG. 3C, in some embodiments non-holographic 13 portion(s) of design 12 may be provided at any locations within CE on the blank B. In some embodiments, top graphics and copy may be provided within the A (top panel) position, and side graphics and copy may be located between the F and D positions. Knurls may be formed along the F and/or D positions. In some embodiments, embossing and non-holographic debossing may be provided anywhere within the CE position, such as for example, within A, between F and D.

Collectively, FIGS. 3C and 3D illustrate distinct views of closure 10. FIG. 3C is a top plan view of the portion of sheet 20 that will be cut from sheet 20 to form closure 10. FIG. 3D is a side-view of closure 10 of FIG. 3C. Transition points labeled in FIG. 3C correspond to FIG. 3D, such as “TP” in FIG. 3 corresponding to top panel 19. Element “A” in FIG. 3C corresponds to the transition from top panel 19 in FIG. 3D to skirt 18, element “F” in FIG. 3C corresponds to position “F” on skirt 18 as illustrated in FIG. 3D, element “D” in FIG. 3C corresponds to position “D” on skirt 18 as illustrated in FIG. 3D, and element “CE” in FIG. 3C corresponds to position “CE” on skirt 18 as illustrated in FIG. 3D.

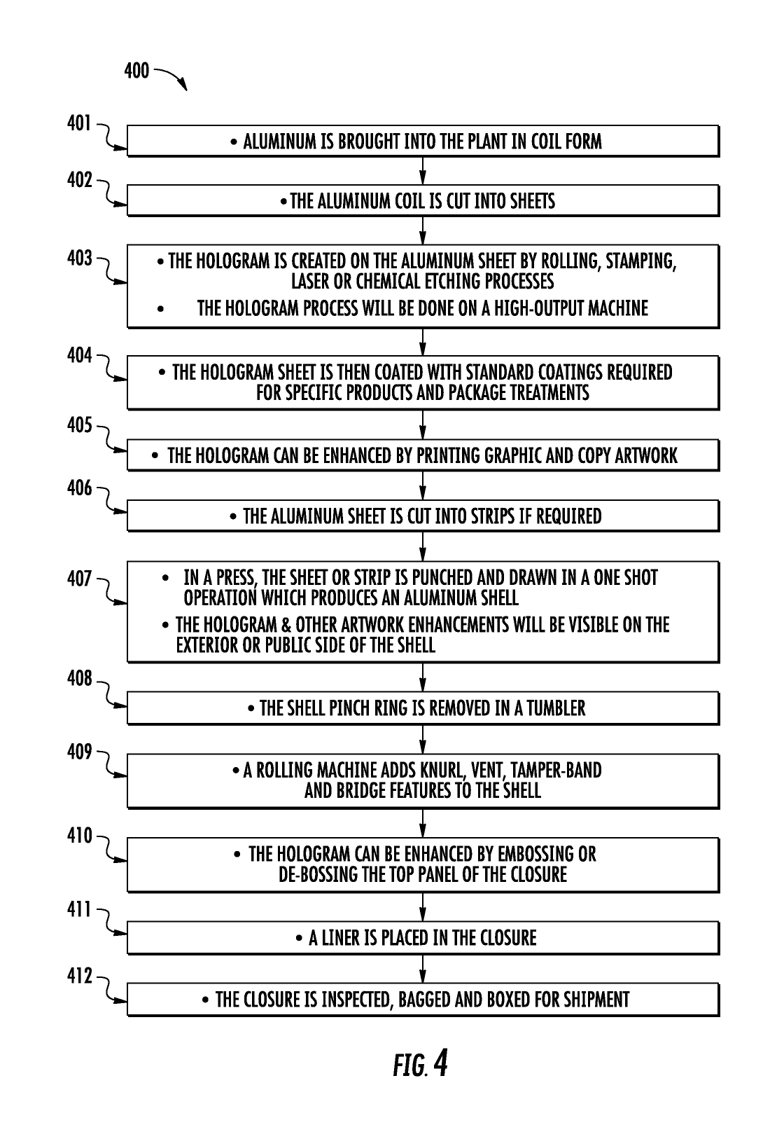

Turning now to FIGS. 4-7, several methods of forming roll-on pilfer proof closure (“ROPP”) having an enhanced closure design comprising holographic 11 and non-holographic 13 portions are described. As an initial step 401 in the closure 10 formation process 400, a material is provided from which closures 10 are to be formed. The material may be provided in any desired form. For example, in some embodiments, the material may be provided as a roll or coil. In other embodiments, the material may be provided as sheets. In yet other embodiments, the material may be provided as smaller-sized strips.

The size of the material may be modified prior to and/or during the closure formation process. For example, in some embodiments the material may be provided in a coil form, with the material being unrolled from its coiled form and worked on in a continuous manner during the closure formation process. In other embodiments, prior to and/or during the closure formation process, the material provided in a coil form may be cut into smaller sheets (step 402) and/or strips. Similarly, material initially provided in sheet form may be cut into strips prior to and/or during the closure formation process.

In some embodiments, the method of forming closures having combined holographic 11 and non-holographic 13 designs comprises the step of forming one or more holograms on the closure and/or the material used to form closure 10 (step 403). The hologram(s) defining the holographic 11 portion of the design may be formed using any one of, or any combination of methods and devices as described above and/or known to those skilled in the art. The hologram(s) may be formed about any desired portion(s) of the surface of closure 10 and/or the surface of the closure-forming material as described above. Once the hologram(s) has been formed, closure 10 and/or material forming closure 10 may optionally be treated and/or coated as desired and/or required to comply with packaging regulations (step 404).

The holographic 11 portion may be enhanced by printing graphics and/or copy artwork on the same portion(s) or neighboring portions (step 405), and subsequently the material may be cut into strips if required (step 406). The strips are then punched and drawn into the shape of an aluminum shell (step 407), with the hologram and other artwork preferably, although not necessarily, visible on the exterior surfaces. The shell pinch-ring is then removed (step 408), and optionally a machine, such as a rolling machine, adds knurls, vents, tamper-band and bridge features to the closure shell as desired (step 408).

Optionally, the hologram can be enhanced by embossing or debossing the top panel of the closure shell (step 409). The hologram can be enhanced by embossing or debossing the top panel of the closure (step 410). Subsequently, a liner is placed in the closure 10 (step 411), and the closure 10 is inspected and shipped (step 412).

Alternatively, in some methods of forming closure 10, the material from which closure 10 is to be formed may be provided preformed with one or more hologram. In such embodiments, the arrangement of the preformed hologram(s) about the surface of the provided coil, sheet, or strip of material may correspond to any of the arrangements as discussed with reference to and illustrated in FIGS. 3A-3E, such as, for example, arrangements in which holograms are formed about only those portions of the material that correspond to portions of the material that will form the blanks and/or the top panels 19 of the closures 10.

Depending on the desired decorative effect for closure 10, closure 10 and/or the material from which closure 10 is made may undergo one or more rounds of printing and/or other surface treatment steps necessary to create the desired non-holographic 13 portion(s) of closure 10 design 12. It is to be understood that in some embodiments, these steps may occur before and/or after the creation of hologram(s) on the surface of the closure 10 and/or the material from which the closure 10 is made. Once the desired combined holographic 11 and non-holographic 13 designs have been formed, closure 10 and/or the material forming the closure may optionally be coated with a seal and/or varnish to protect the design.

It may optionally be desired to include one or more registering and/or indexing steps during the steps of forming the holographic 11 and/or non-holographic 13 portions of closure 10 design 12 to ensure that the various holographic 11 and non-holographic 13 design elements forming the overall closure design are properly aligned and oriented to one another and relative to the closure and/or the material forming the closure in order to create the desired visual effect for closure 10.

For example, given that the micro-debossed portions of the material forming the hologram will create different visual effects based upon the manner in which light is refracted off of the surface of the material, it may be desired to not only ensure that the non-holographic 13 portion of the design is aligned with respect to the portion of closure 10 and/or the closure-forming material about which the hologram(s) is formed, but also that non-holographic 13 portion of design 12 is oriented in the appropriate direction relative to the orientation of hologram formed on closure 10 and/or the closure-forming material.

After providing the material from which closure 10 is to be formed, the process of creating closure 10 comprises the steps of cutting or stamping the material into circular discs, or blanks, sized to produce closure 10 having a particular cross-sectional diameter; as well as forming the blanks into cup-shaped members having top panel 19 and a downwardly depending annular sidewall/annular skirt 18. The free, lower ends of the annular sidewalls of the cup-shaped members may optionally be trimmed to produce closure 10 having an annular skirt 18 having a uniform height, and a liner may optionally be provided within closure 10 to assist in forming a seal with the container to which closure 10 is to be applied.

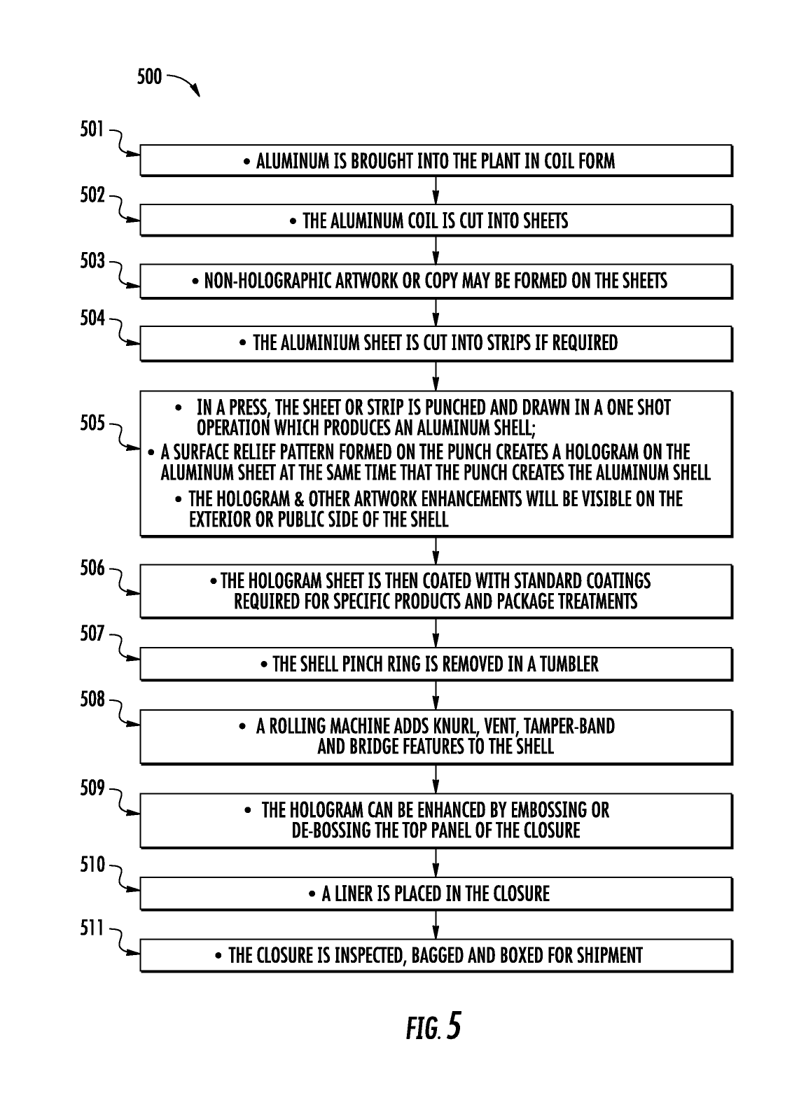

As illustrated in FIG. 4, in one embodiment of a method of forming closure 10 having a combined holographic 11 and non-holographic closure 10 design, the step of forming blanks into cup-shaped members occurs subsequent to the formation of one or more holograms in the material used to form closure 10. However, referring to FIG. 5, in other embodiments, it may be possible to form the hologram(s) in the material from which closure 10 is made during the step of drawing blanks to form cup-shaped members. In such embodiments, the cup-forming surface of the die punch that is used during the cup forming step may include a surface relief portion 40, such that, in addition to resulting in the formation of a cup-shaped member, the engagement of the die punch with the blank also results in the creation of the hologram(s) forming holographic 11 portion(s) of closure 10 design along top panel 19 of closure 10.

The annular sidewalls of the cup-shaped members may optionally be knurled to facilitate removal of closure 10 from a container. Additionally and/or alternatively, the lower portion of annular skirt 18 may optionally be scored and/or deformed to form a tamper band for closure 10.

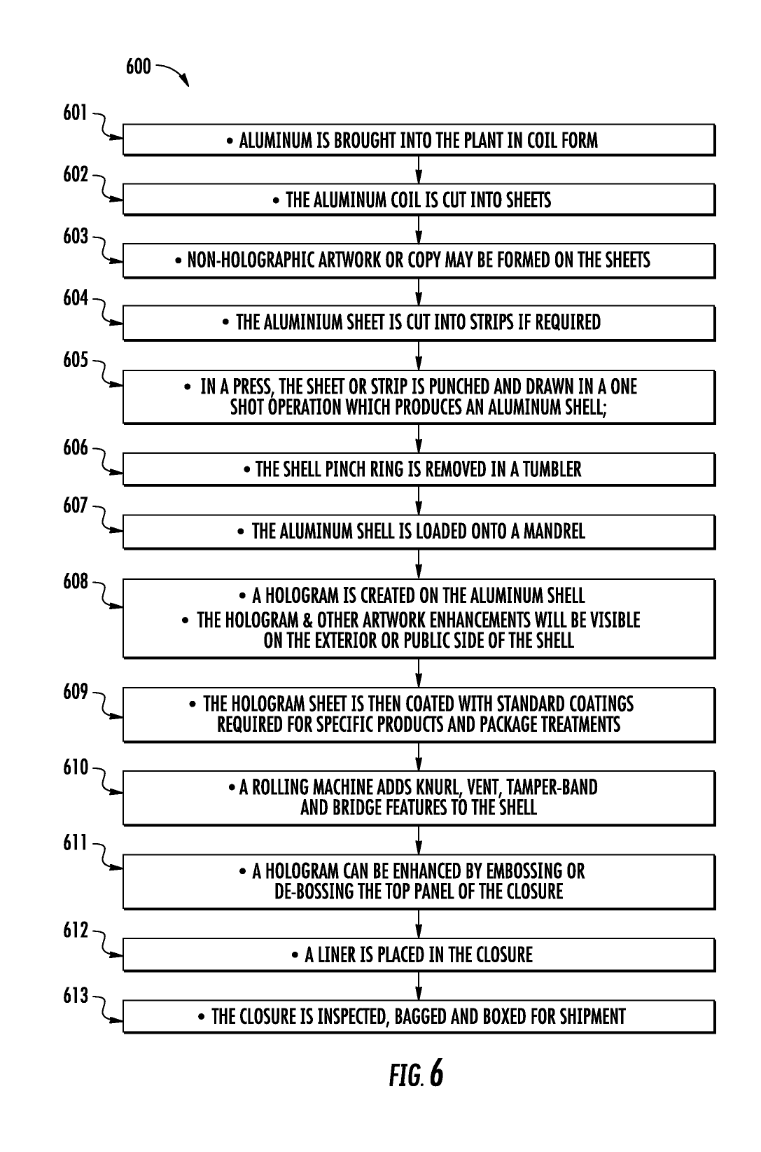

In some embodiments, closures 10 may be loaded onto mandrels in order to form the knurled and/or tamper band portions of closure 10. As illustrated in FIG. 6, in some embodiments, the steps of creating holographic 11 and/or non-holographic 13 portions of closure 10 design may occur entirely or in-part after the closure 10 has been loaded onto the mandrel, and either prior to, during, and/or subsequent to the steps of forming knurls and/or the tamper band. In other words, closure 10 may be entirely or partially undecorated prior to being loaded onto the mandrel. Optionally, once loaded onto the mandrel, closure 10 may additionally or alternatively undergo embossing or non-hologram forming debossing along any portion of closure 10.

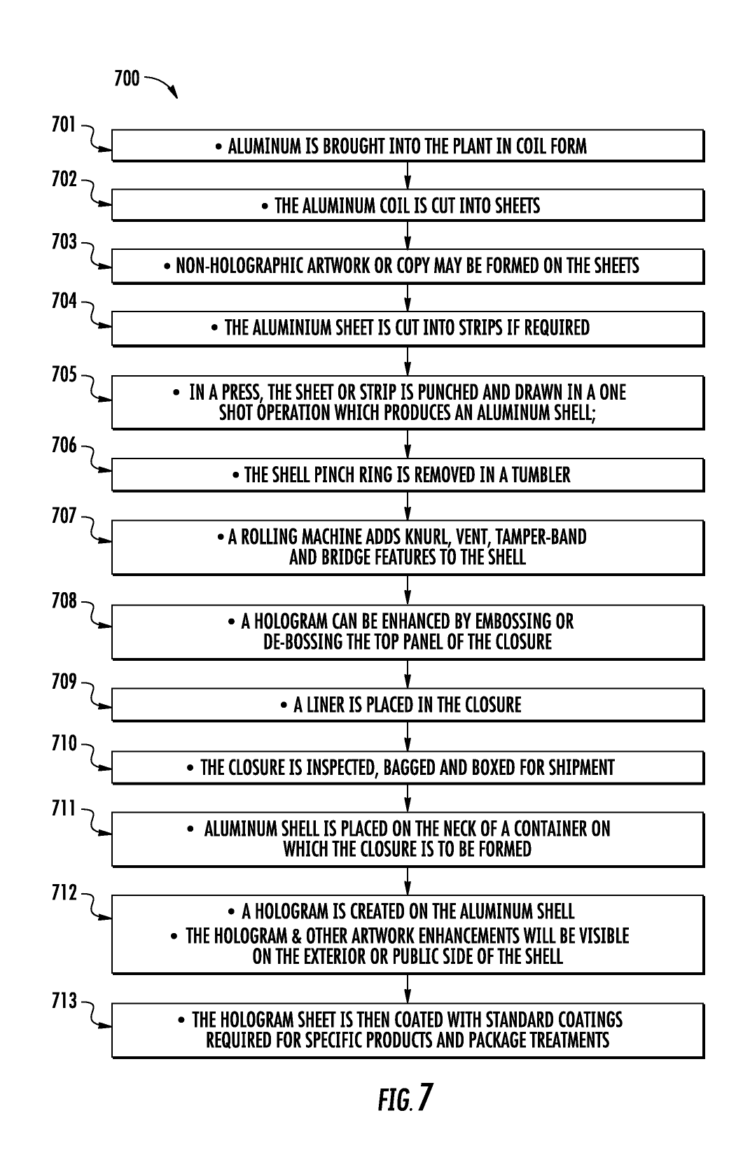

As illustrated in FIG. 7, in yet other embodiments of forming closure 10 having a combined holographic 11/non-holographic 13 design, closure 10 may remain entirely or partially undecorated (i.e. formed without holographic 11 and/or non-holographic 13 portion(s) of closure 10 design 12) all the way through closure 10 formation and storage of the closure 10. In such embodiments, the decoration of the entirety or portions of closure 10 with holograph 11 and/or non-holographic 13 designs may be completed only after closure 10 has been applied to a container—either during or after the process of interconnecting and sealing closure 10 to the container.

Although closures 10 described with reference to the methods above have been referenced as roll-on pilfer-proof (“ROPP”) closures, it is to be understood that similar methods, steps and principles may be applied to form any number of similar types of closures, including, but not limited to: crown closures, lugged closure, etc. It is also to be understood that while such closures 10 may be formed of various conventional metallic materials such as aluminum, tin, steel, tin-coated steel, and alloys thereof, closures 10 may also be formed of other metals or metal alloys, plastics, cardboard, paper, fiber reinforced materials, and the like.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present disclosure.

While the current application recites particular combinations of features in the claims appended hereto, various embodiments of the disclosure relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A closure comprising:
a top panel having an upper surface, a lower surface and an outer periphery;
a skirt extending downwards from the outer periphery of the top panel, the skirt having an outer surface and an inner surface, the skirt outer surface and the top panel upper surface collectively comprising an external surface; and
a design covering at least part of the external surface, the design comprising a first design portion of a hologram and a second design portion without a hologram.

2. The closure of claim 1, wherein the first design portion covers at least part of the skirt outer surface and the second design portion does not cover any of the skirt outer surface.

3. The closure of claim 1, wherein the first design portion covers at least part of the top panel upper surface and the second design portion does not cover any of the top panel upper surface.

4. The closure of claim 1, wherein the first design portion does not cover any of the skirt outer surface.

5. The closure of claim 1, further comprising:
a plurality of knurls extending about an upper portion of the skirt;
a tamper band formed along a lower portion of the skirt; and
an annular portion defined between the knurls and the tamper band, the first design portion covering part of the top panel upper surface and the annular portion of the skirt.

6. The closure of claim 1, wherein the second design portion comprises one or more printed layers.

7. The closure of claim 1, wherein the second design portion is oriented on the external surface of the closure relative to the first design portion.

8. A metallic sheet configured to form container closures, the sheet comprising:
an upper surface;
a lower surface;
a leading end;
a trailing end;
a top end;
and a bottom end;
a first plurality of circles defined along the upper surface of the sheet, at least one of the first plurality of circles being surrounded by six circles from the first plurality of circle, the first plurality of circles being arranged in a repetitive pattern along the upper surface of the sheet;
a second plurality of circles arranged within the first plurality of circles; and
one or more holograms covering portions of the upper surface within the second plurality of circles.

9. The sheet of claim 8, wherein the first plurality of circles are equally sized relative to each other.

10. The sheet of claim 8, the one or more holograms only covering portions of the upper surface within the first plurality of circles.

11. The sheet of claim 8, the one or more holograms only covering portions of the upper surface within the second plurality of circles.

12. The sheet of claim 8, the first plurality of circles having an outermost periphery defining a first boundary, the sheet further comprising a non-holographic design covering portions of the upper surface within the first boundaries defined by the first plurality of circles.

13. The sheet of claim 12, the non-holographic design only covering the portions of the upper surface within the first boundaries defined by the first plurality of circles.

14. The sheet of claim 13, the non-holographic design only covering the portions of the upper surface between the first boundaries and the second plurality of circles.

15. A method of forming a closure having a holographic design, comprising:
providing a metallic sheet;
forming one or more holograms on an upper surface of the sheet;
forming a non-holographic design on the upper surface of the sheet; and
forming one or more cup-shaped members from the sheet, the one or more cup-shaped members comprising a top panel and an annular skirt.

16. The method of claim 15, wherein the sheet is registered prior to creating the non-holographic design such that the non-holographic design is aligned to create the non-holographic design at desired locations along a length of the sheet.

17. The method of claim 16, wherein the alignment of the non-holographic design during registering is based on the relative alignment of the one or more holograms along the upper surface of the sheet.

18. The method of claim 17, wherein the sheet is indexed prior to creating the non-holographic design such that the non-holographic design is formed at a desired orientation along the sheet.

19. The method of claim 15, wherein the one or more holograms are only covering portions of the sheet that correspond to the top panels of the cup-shaped members.

20. The method of claim 15, wherein the non-holographic design comprises one or more layers of printing.

21. The method of claim 15, further comprising the step forming a plurality of knurls along a portion of the annular skirt.

22. The method of claim 15, the cup-shaped member being mounted onto a mandrel to form the plurality of knurls, and the hologram being formed along an upper surface of the sheet after the cup-shaped member has been mounted onto the mandrel.
